(19) United States
(12) Patent Application Publication
(10) Pub. No.: US 2018/0266158 A1
(43) Pub. Date: Sep. 20, 2018

(54) DOOR CONTROL UNIT

(71) Applicant: Marantec Antriebs- und Steuerungstechnik GmbH & Co. KG, Marienfeld (DE)

(72) Inventor: Marc HELLWEG, Bielefeld (DE)

(21) Appl. No.: 15/921,558

(22) Filed: Mar. 14, 2018

(30) Foreign Application Priority Data
Mar. 15, 2017 (DE) 10 2017 002 543.6

(51) Int. Cl. E05F 15/00

(52) U.S. Cl. CPC E05F 15/00; E05Y 2900/132; E05Y 2900/106; E05Y 2400/10

(57) ABSTRACT

A door control unit for controlling the actuation of a door. In at least one example, the door control unit may comprise a drive unit which is designed to output actuation signals for a door, and a computer unit which has a connection with the drive unit and is designed to communicate with an actuating unit for the door, wherein the computer unit furthermore is designed to operate an operating system which utilizes a software module for the communication with the actuating unit.

### CROSS REFERENCE TO RELATED APPLICATION

This application claims priority to German Patent Application No. 10 2017 002 543.6, entitled “Door Control Unit,” filed Mar. 15, 2017. The entire contents of the above-referenced application are hereby incorporated by reference in their entirety for all purposes.

### TECHNICAL FIELD

The present disclosure relates to a door control unit, in particular to a garage door or entrance door control unit for actuating a corresponding door.

### BACKGROUND AND SUMMARY

In today's context it has become more and more important for a door control unit to be accessible for a plurality of different devices. Meanwhile, it is advantageous when a door control unit not only is controllable by means of a separate actuating element adjusted to the door control unit, but is actuatable by a plurality of devices.

However, as during the manufacture of the door control unit it is impossible to provide a corresponding matching with all actuating elements occurring during the product life of the door control unit to achieve a smooth actuation of the door control unit, many door control units are limited in their connectivity after a certain period. It should also be noted that the interfaces for the communication with already existing actuating elements in general also require a constant adaptation, as most actuating devices constantly are updated in terms of software.

It is the objective of the present disclosure to create a door control unit which overcomes the problems raised above.

Accordingly, a door control unit according to the present disclosure comprises a drive unit which is designed to output actuation signals for a door, and a computer unit which has a connection with the drive unit and is designed to communicate with an actuating unit for the door, wherein the computer unit furthermore is designed to operate an operating system which utilizes a software module for the communication with the actuating unit.

Due to such a construction of a door control unit it is possible to react to changes in a specific actuating unit by adapting the software module. Moreover, a new software module can be added to the computer unit, in case it is desired that an actuating unit communicates with the door control unit for which no appropriate software module was present so far.

The separation of computer unit and drive unit substantially provides that the drive unit always outputs the same actuation signals for controlling the door, which signals are converted by the computer unit from a format specific for an actuating element.

According to an optional modification of the present disclosure the software module is adjusted to the actuating unit, in particular to its communication interface or its operating system. This allows to take account of circumstances specific for the actuating unit and to obtain a connectivity of the door control unit as variable as possible.

According to another development of the present disclosure the computer unit is designed to generate the software module for the communication with the actuating unit.

Furthermore, according to the present disclosure it can be provided that the computer unit includes a plurality of software modules, each of which is adjusted to a specific type of an actuating unit.

In one example, the software module is an API, i.e. an application programming interface, in order to provide for a connection of the actuating unit to the drive unit. It can be provided that such software module is configured in the form of a plug-in, i.e. is to be regarded as an independent additional software module which can be added to the computer unit as required.

According to an optional modification of the present disclosure, the computer unit includes a dynamic M2M stack (=machine-to-machine stack) for the communication with the drive unit. By means of this dynamic it is possible to react to the further development in an actuating unit in order to obtain the connectivity to this unit.

Furthermore, it can be provided that the present door control unit is designed to send data on a condition of the door control unit via an interface to a server via the Internet, so that a maintenance work can be initiated on the basis of the transmitted data.

In addition, the present disclosure can be provided with a virtual access authorization which permits a change of settings of the door control unit only after a previous comparison of keys. A key here is stored in a server connected with the Internet, so that in the case of an access to the door control unit a corresponding key is queried and changes only can be made when a comparison with a key stored in the server verifies the authenticity of the entered key. Thus, an access authorization of the door control unit can be administered by the keys deposited on the server.

According to the present disclosure it can also be provided that the computer unit of a server includes an interface which establishes a communication with the Internet, wherein the computer unit may be designed to receive a software module via the server interface or to permit a modification of a software module via the server interface. It can also be provided that a software module is inserted via a connection present between the actuating unit and the computer unit.

A third-party provider or the manufacturer of the door control unit thereby is allowed to modify the software module of a particular actuating unit via the server interface. This is advantageous for example when an actuating unit for actuating a door undergoes a change in terms of software or hardware, which requires an adaptation of the software module for the communication with the door drive. Then it is possible to access the software module via this server interface and a corresponding adaptation can be made.

Furthermore, it can be provided according to the present disclosure that the computer unit is arranged in a common housing with the drive unit or communicates via a local area network such as Bluetooth or WLAN without utilizing an Internet connection. It thereby is ensured that the computer unit is physically present in direct vicinity of the drive unit and a cloud-based calculation does not take place. This is advantageous, as safety-critical applications should not rely on cloud-based calculation results in order to be fully operable also during an inevitable downtime of the Internet of one to two minutes per day.

According to another optional modification of the present disclosure the computer unit includes a CPU, a working memory, and a main memory.

It can also be provided that the computer unit is designed to receive an actuation command of an actuating unit which actuates the drive unit, to convert the same by means of an associated software module and to communicate the same to the drive unit in the converted form. In the process, that software module is chosen which is adjusted to the actuating unit.

It can furthermore be provided that the computer unit comprises an interface which allows an access to the calculating unit itself and to the software modules deposited in the computer unit, wherein the interface may be an MQTT interface, a Bluetooth interface and/or an NFC interface.

It can also be provided that the computer unit is designed to serve as a gateway, wherein the computer unit may be provided with an operating system on an open-source basis.

According to a preferred embodiment of the present disclosure the drive unit includes a microcontroller for converting the actuation signals sent by the computer unit.

The present disclosure furthermore relates to a door, in particular a garage door or an entrance door, which is provided with a door control unit of the variants listed above.

Further features, details and advantages of the present disclosure will become apparent with reference to the description of the only Figure.

### BRIEF DESCRIPTION OF THE FIGURE

FIG. 1 shows a structural schematic diagram concerning the construction of a door control unit according to the present disclosure.

### DETAILED DESCRIPTION

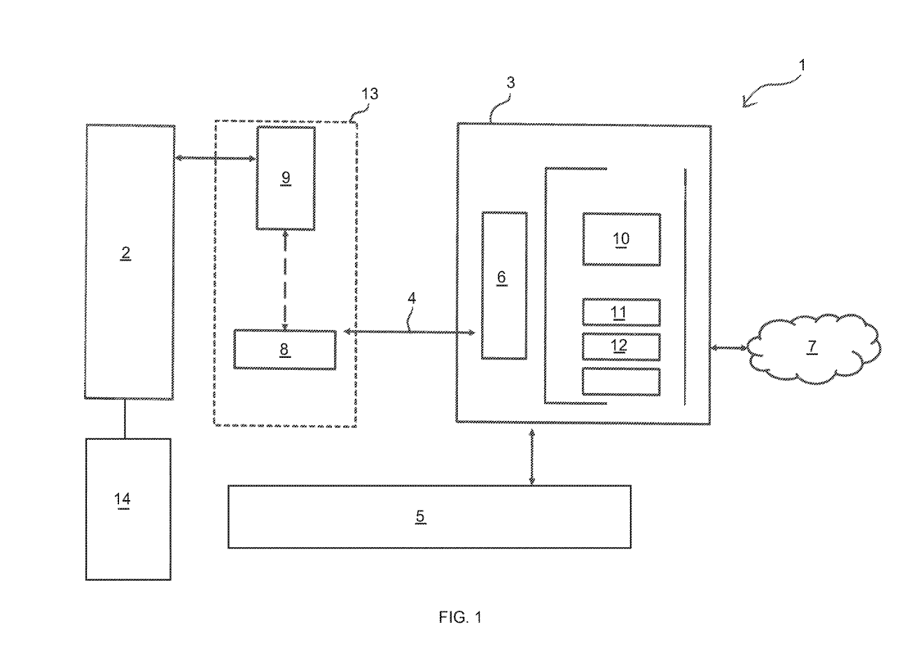

Beside the drive unit 2, the door control unit 1 shown in FIG. 1 includes a computer unit 3. The computer unit 3 has a CPU 10, a server interface 11 and a working memory 12 as well as a software module 6.

This software module 6 provides for converting a command for the drive unit 2 of an actuating unit 5. The actuating unit 5 is connected with the computer unit 3 for example via a Bluetooth connection, an NFC connection or an MQTT connection. In at least one example, actuating unit 5 may comprise an interface to receive a command,such as a user command, and the actuating unit 5 may communicate the received command to computer unit 3.

For example, the interface of unit 5 for receiving the command may be any one or combination of a touch screen, a button, visual sensor, biometric sensor, and microphone. The command may be a command to open or a command to close door 14, for example. The server interface 11 of the computer unit furthermore is designed to communicate with the Internet 7. It therefore is possible that via the server interface 11 data stored on a cloud network of remote servers hosted on the Internet 7 are provided to the computer unit 3.

By means of the system shown in FIG. 1 the data stream from the respective drive unit 2 can be captured globally and e.g. be analyzed in more detail in the case of a connection to the Internet (connection between 7 and 3), so that conclusions as to possible errors in the system can be drawn. In the case of certain indicators, such as an exceedance of a door cycle indication (E²Prom, from 2), the customer of the respective drive by means of this system therefore can be offered a service date in good time and before a technical failure of the system 1 actually occurs, which due to an analysis of the data to be captured via the Internet is regarded as advantageous. This “anticipating” maintenance reduces the downtimes of the system and relieves the user of observing maintenance intervals or organizing maintenance work on the system.

Furthermore, it can be provided that all required materials for the service technician carrying out a maintenance are collected already in advance to avoid that this must happen only during the on-site analysis. The maintenance time thereby is reduced.

It can also be provided that several datasets are stored in the computer unit 3 (e.g. a service interval), which after a certain time or a certain consumption (e.g. door cycles carried out) automatically generates a service request and communicates the same to a corresponding point via the Internet.

As format the identifier standard UUID (=Universally Unique Identifier) is useful, which can be employed by the computer unit 3 or 13. Furthermore, it is also conceivable that the dataset with geographical data and/or customer data thus also is specifically used for an analysis or for a service request.

In the computer unit 3 preliminary analyses can also be made, which are directed to possible service data or particular wear information and which then are each communicated to a server based in the Internet 7 according to priorities.

Furthermore, it can also be provided that a virtual access authorization is present for the access to adjustment possibilities of the system. It is advantageous when not every user is permitted to change the settings of a door system. Therefore, it is also possible with the present disclosure to produce and verify an exchange of a virtual key which can be generated as described below. This key thus replaces a physical verifying operation and converts this procedure into the virtual plane.

A specialist dealer or a commercial service provider accordingly has the possibility to have himself authenticated for an authorization which allows to make changes in the system 1, via the Internet connection 7 of the system 1. It can be provided that a specialist dealer can split a virtual authorization associated with his customer data into individual authorizations (base number globally, for each specialist dealer dataset, token, TAN, code, key or the like), so that the same then can equip his service employees with corresponding virtual authorizations which provide for changing a specific system. Hence, an individual authorization can contain the individual ID number of an associated system which permits a modification of exactly this system only.

Such authorization is provided to the system 1 via the Internet 7 and stored in the computer unit 3, so that after a transmission via the connection 4 it can be utilized for the purpose of the expanded adjustment possibilities of the drive unit 2. This virtual access authorization for making adjustments accordingly is in a position to enable or again withdraw an authorization to make changes to the system 1 via the connection with the Internet 7.

Furthermore, the software module 6 is connected with the drive unit 2 via the connection 4. In at least one example, actuating unit 5 may communicate a command received via the actuating unit 5 to computing unit 3. Computing unit 3 may then communicate the command to drive unit 2. In one example, computing unit 3 may directly communicate the command to drive unit 2, and then drive unit 2 may actuate door 14 responsive to the received command.

Alternatively, computing unit 2 may communicate the command to computing unit 13 for further processing prior to communicating the command to drive unit 2. Computer unit 13, the rectangle with the reference numeral 13 shown in broken lines, is optional for the present disclosure and represents a further drive-side converter 8 as well as a microcontroller 9. It can hence be provided that the software module 6 converts the commands of an actuating unit 5 into a first format and the converter 8 converts this first format into a second format with which the microcontroller 9 then is able to execute an actuation of the drive unit 2. For example, the actuation of the drive unit 2 may include opening or closing door 14. The connection between the microcontroller 9 and the converter 8 can be effected in a cable-bound or wireless manner. As an example for a cable-bound connection reference is made to the communication by means of RS485. In more recent drive generations the computer unit 13 shown in broken lines typically is not necessary any longer. The software module 6 then will directly cooperate with the drive unit via its connection 4.

The advantage of this door control unit consists in the fact that the software module in the manner of a plug-in is adjustable to a particular actuating unit 5 and can be implemented to the computer unit in a simple way. When a new kind of an actuating unit 5, which was not known yet in the conception of the door control unit 1, now is created on the market, it can now be provided by uploading the software module into the computer unit 6 that this new actuating unit 5 can communicate not in the machine language of the drive unit 2, but in a language inherent to the actuating unit 5. A much simpler application to the actuating units thereby is achieved, so that the flexibility of the door control unit also increases considerably.

In addition, it is possible to arrange for making updates of a software module via the Internet access of the computer unit 3, without the operating system of the computer unit 3 having to be changed or adapted. Due to the architecture of the operating system on the computer unit 3 and the separate software module 6 not being structurally interwoven, it is unproblematic throughout the service life of the door control unit to develop further new software modules 6 and upload the same into the computer unit 3. This ensures a particularly good connectivity throughout the life cycle of the door control unit.

The addition of software modules 6 in the manner of plug-ins which are adjusted to a particular type or a particular version of an actuating unit 5 constitutes a significant facilitation during the operation of the door control unit.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the present disclosure.

1. A door control unit for controlling actuation of a door, comprising:
a drive unit which is designed to output actuation signals for the door; and
a computer unit which has a connection with the drive unit and is designed to communicate with an actuating unit for the door, wherein
the computer unit furthermore is designed to operate an operating system which utilizes a software module for the communication with the actuating unit.

2. The door control unit according to claim 1, wherein the software module is adjusted to the actuating unit.

3. The door control unit of claim 2, wherein the software module is adjusted to a communication interface or an operating system of the actuating unit.

4. The door control unit according to claim 1, wherein the computer unit is designed to generically generate the software module for the communication with the actuating unit.

5. The door control unit according to claim 1, wherein the computer unit includes a plurality of software modules, each of which is adjusted to a specific type of the actuating unit.

6. The door control unit according to claim 1, wherein the software module is an API.

7. The door control unit of claim 6, wherein the API is configured in a plug-in form.

8. The door control unit according to claim 1, wherein the computer unit includes a dynamic M2M stack for the communication with the drive unit.

9. The door control unit according to claim 1, wherein the computer unit includes a server interface which can establish a communication with the Internet.

10. The door control unit according to claim 9, wherein the computer unit is designed to receive the software module via the server interface or to permit a modification of the software module via the server interface.

11. The door control unit according to claim 1, wherein the computer unit is arranged in a common housing with the drive unit or communicates via a local area network, such as Bluetooth or WLAN, without utilizing an Internet connection.

12. The door control unit according to claim 1, wherein the computer unit includes a CPU, a working memory, and a main memory.

13. The door control unit according to claim 1, wherein the computer unit is designed to receive an actuation command of an actuating unit which actuates the drive unit, to convert the same by means of an associated software module, and to communicate the same to the drive unit in the converted form.

14. The door control unit according to claim 1, wherein the computer unit comprises an interface which allows an access to the computer unit itself and to the software module deposited in the computer unit, wherein the interface is an MQTT interface, a Bluetooth interface and/or an NFC interface.

15. The door control unit according to claim 1, wherein the computer unit is designed to serve as a gateway.

16. The door control unit according to claim 15, wherein the computer unit is provided with an operating system on an open-source basis.

17. The door control unit according to claim 1, wherein the drive unit includes a microcontroller for converting the actuation signals sent by the computer unit.

18. The door control unit according to claim 1, wherein the computer unit is designed to allow changes to the operating system or the door control unit only when the input of a verification authorization complies with a corresponding verification deposited on a server.

19. A door, comprising:
a door control unit, the door control unit comprising:
a drive unit which is designed to output actuation signals for the door; and
a computer unit which has a connection with the drive unit and is designed to communicate with an actuating unit for the door, wherein the computer unit furthermore is designed to operate an operating system which utilizes a software module for the communication with the actuating unit.

20. The door according to claim 19, wherein the door is a garage door or an entrance door.
